(19) United States
(12) Patent Application Publication
(10) Pub. No.: US 2018/0270679 A1
(43) Pub. Date: Sep. 20, 2018

(54) RELIABILITY-BASED MULTI-LINK COMMUNICATIONS

(71) Applicant: Nokia Technologies Oy, Espoo (FI)

(72) Inventors: Daniela LASELVA, Klarup (DK); Hans Thomas HOEHNE, Helsinki (FI)

(73) Assignee: Nokia Technologies Oy

(21) Appl. No.: 15/463,422

(22) Filed: Mar. 20, 2017

(51) Int. Cl. H04W 24/08; H04W 72/08

(52) U.S. Cl. CPC H04W 24/08; H04W 72/085

(57) ABSTRACT

A network, for example a master node interworking with other network nodes, determines a reliability target for radio communications, and computes a first single multi-link reliability metric with a multi-mode device across a first set of multiple radio links that are simultaneously active for the multi-mode device. In the examples that reliability metric enumerates an overall probability to successfully communicate a certain volume of digital data within a certain time constraint. The network further compares the first single multi-link reliability metric to the reliability target, and in response to that comparing the network signals the multi-mode device with 1) an indication of the first set of multiple radio links that if utilized by the multi-mode device simultaneously would satisfy the reliability target, and/or with 2) a notification of the single multi-link reliability metric associated with the first set.

### TECHNOLOGICAL FIELD

The described invention relates to wireless communications, and more particularly to selecting which radio links multi-mode devices (e.g., user equipments or UEs) should use simultaneously even where the links can employ the same or different radio access technologies (RATs).

### BACKGROUND

Acronyms used herein are listed below following the detailed description. As used herein, a multi-mode device may use more than one radio link simultaneously. Such links can employ the same or different radio access technologies (RATs), and may belong to the same or different cells/access points. For the case of multiple different RATs these may be embodied as hybrid networks which in some deployments combine loosely coupled technologies and in others more tightly integrated technologies. Some non-limiting examples include user equipments (UEs) equipped with 5^{th} generation/new radio (5G NR) and with 4^{th} generation/long term evolution (LTE) radios; or with 5G NR and Wi-Fi radios; or with 5G NR and LTE and Wi-Fi radios; or with LTE and Wi-Fi radios. Also the device may be using multi-connectivity within the 5G RAT, for example with two or more simultaneously active NR links. Furthermore the device may be using any of the mentioned link combinations together with sidelink-sidelink such as device-to-device (e.g., Bluetooth®).

5G NR is a new RAT being developed by the 3GPP organization to meet ever increasing demand for wireless communications and may operate on multiple frequency bands, for example the mmWave frequency band, generally 6 GHz and higher (even up to 100 GHz). Some of the 5G NR service targets are enhanced mobile broadband (eMBB) and massive machine-type communications (m-MTC) with ultra/high-reliability and ultra-low latency (URLLC or sometimes HRLLC).

FIG. 1A is an example radio environment to demonstrate such multiple available links across multiple RATs, namely LTE, 5G NR and WLAN/Wi-Fi where the Xn and Xw interfaces show there is some interworking between each of the LTE and WLAN systems with the 5G NR system. There is an eNB 20 that is the radio access node operating with LTE technology and nearby there is a gNB 25 operating with 5G technology. In practice the gNB may be implemented as one or multiple remote radio heads operating in conjunction with a baseband unit located up to several kilometers away. The eNB 20 shares information on what is currently termed a Xn interface which may be wired or wireless. There are many ways the eNB and gNB can cooperate to serve a UE. In one non-limiting example the gNB is operating essentially as a secondary cell SCell for a given UE on a 5G frequency band and the eNB is serving that same UE as its primary cell PCell on a LTE frequency band. As illustrated the 5G RAN operates independently with its own 5G core network while the LTE eNB 20 operates with its evolved packet core (EPC) network, while in other deployments (particularly as 5G NR initially rolls out) the gNB may share the EPC. The WLAN access point (AP) 28 has a link with the UE on license-exempt frequency bands and the channel access is completely different than that of either the LTE or 5G NR systems, and where there is not a tight 5G NR-WLAN interworking data that passes through the AP 28 may go directly to/from the Internet rather than be routed through either the EPC or NG core. FIG. 1A is merely an illustration; there is a wide variety of possibilities for implementing hybrid networks that utilize multiple RATs to provide the multiple radio links that a UE can simultaneously use for its data.

Typically such capability of multi-link connectivity has been exploited for boosting capacity; throughput in a given time. Embodiments of these teachings look at multi-link connectivity from the perspective of increased reliability, and particularly to leveraging redundancy and diversity offered by the available multiple networks to improve reliability. A higher reliability, even up to the so-called ‘5-nines’ (99.999% reliability), may be required by emerging mission critical use cases for example in the areas of process automation, factory automation, remote control, assisted and autonomous vehicles, so-called cyber-physical systems (CPS), and other mission-critical applications. In 5G NR terminology this is referred to as URLLC or HRLLC. The 3GPP organization defines reliability as a composite metric of latency and packet loss ratio; the probability to transfer successfully X bytes within a certain delay budget. The metric threshold is not fixed for all use cases but the delay budget may be strict, for example 1 ms. Reliability for these teachings are consistent with the 3GPP definition.

A problem arises in that a mission-critical device which has several active radio links at its disposal would ideally be able to determine how to utilize those available links for ensuring the required level of reliability. For example, the link decision to meet a data reliability metric can be whether to use a single link or multiple links at any given time among the available links, or if there are 3 or more links available which two or more links will best meet the reliability metric. Of course reliability can be maximized in many cases by utilizing all available links simultaneously for data, but this is not practical when there are multiple multi-mode devices making similar decisions because even with multiple RATs on multiple frequency bands the amount of radio spectrum remains a limited resource and so must be used efficiently. Further, also UE battery consumption is impacted by using multiple links at the same time. So the decision is to choose which link or links for sending the data to meet the reliability metric in a spectrum-efficient manner and/or battery efficient manner. In some instances simultaneously using a LTE link along with a 5G NR link will be the most spectrum-efficient choice to meet a given reliability metric, while in other instances that combination will not meet the reliability constraints and 2 5G NR links in addition to a WLAN/Wi-Fi link is the best choice.

This is not to say that all the UE's data is always transmitted on each and every one of the selected multiple links; there are a variety of ways to employ transmission redundancy short of wholesale duplicated transmissions on parallel channels. Sometimes this may be how the redundancy is implemented, while in other cases one of the links in a tightly-coupled network for example is utilized only for lower layer reliability improvement, e.g. via HARQ re-transmissions or HARQ incremental redundancy transmissions and control signaling. There is a wide variety of ways to implement redundancy when multiple links are in simultaneous use.

While the inventors are not aware of research or solutions specific to choosing what link combination will meet a reliability metric, some relevant teachings may be seen in the following references:
US patent application publication US 2003/0043773 entitled Multilink Wireless Access Scheme for Multiband Operation in Wireless Mobile Networks by Hyokang Chang (published Mar. 6, 2013).
A paper entitled Availability Indication as Key Enabler for Ultra-Reliable Communication in 5G by Hans D. Schotten et al. in 2014 European Conference on Networks and Communications (EuCNC, available at http://ieeexplore.ieee.org/document/6882630/last visited Mar. 6, 2017).

FIG. 1B illustrates some of the radio protocol architecture layers for the user plane in an example eNB 20 and gNB 25 that may be engaged with one another in 5G NR-LTE interworking. Most such layers such as the PDCP, RLC and MAC layers are similar to those long-used in LTE systems. The 5G NR PDCP application protocol (PDAP) is a new sub-layer to handle the quality of service (QoS) flow mapping for service data units (SDUs) of the NG-U interface into different data radio bearers at the radio access network (gNB level). The NR PDAP sub-layer is configured per protocol data unit (PDU) session and can be mapped onto multiple NR PDCP entities. Three bearer types are shown: split, master cell group (MCG), and secondary cell group (SCG).

Further relevant background includes the IETF multi-path transmission control protocol (MP-TCP) which uses TCP properties to infer path properties including round-trip time (RTT) estimation to make forwarding decisions. In general latency is one of the fundamental properties of network paths because it has an impact to retransmissions, protocol performance, and network congestion. Latency estimates can also be used in dual connectivity flow control algorithms that determine how to route each packet on the link with the shortest delay. Further, it is known that in-band measurements often use built-in capabilities of TCP/IP such as the Internet control message protocol (ICMP) echo facility for assessing reachability and latency, and timestamp requests. Traditional QoS parameters are recognized as uplink (UL) and downlink (DL) maximum/guaranteed flow or bit rate, packet delay budget, packet error rate, and allocation and retention priority (ARP) among others. Document 3GPP TR 23.799 defines for 5G also the parameter “notification control” which is intended as notification between the radio access network (RAN) and the core network if the QoS targets are no longer being fulfilled for a QoS flow. Mechanisms related to the notification and how to minimize the notifications to the core network are yet to be determined as 5G is still under development, but the idea of the notification control is to inform the core network of the QoS shortfall so the core network can initiate some corrective modification.

### SUMMARY

According to a first aspect of these teachings there is a method comprising: determining a reliability target for radio communications, computing a first single multi-link reliability metric with a multi-mode device across a first set of multiple radio links that are simultaneously active for the multi-mode device. In the examples herein the single multi-link reliability metric enumerates an overall probability to successfully communicate a certain volume of digital data within a certain time constraint. Further in the method there is a comparing of the first single multi-link reliability metric to the reliability target, and in response to that comparing the method follows up with signaling the multi-mode device with an indication of the first set of multiple radio links that if utilized by the multi-mode device simultaneously would satisfy the reliability target, and/or with a notification of the single multi-link reliability metric associated with the first set.

According to a second aspect of these teachings there is an apparatus comprising at least one computer readable memory storing computer program instructions and at least one processor. The computer readable memory with the computer program instructions is configured, with the at least one processor, to cause the apparatus to at least determine a reliability target for radio communications, and compute a first single multi-link reliability metric with a multi-mode device across a first set of multiple radio links that are simultaneously active for the multi-mode device. The memory with the program instructions and the at least one processor is further configured to cause the apparatus to compare the first single multi-link reliability metric to the reliability target; and in response to the comparing these components further cause the apparatus to perform at least one of a) signaling the multi-mode device an indication of the first set of multiple radio links that if utilized by the multi-mode device simultaneously would satisfy the reliability target, and b) signaling the multi-mode device a notification of the single multi-link reliability target.

According to a third aspect of these teachings there is a computer readable memory storing computer program instructions that, when executed by one or more processors, cause a host device, such as for example a master radio access node operating with (at least) a first RAT, to perform actions comprising: determining a reliability target for radio communications, and computing a first single multi-link reliability metric with a multi-mode device across a first set of multiple radio links that are simultaneously active for the multi-mode device. A further action is to compare the first single multi-link reliability metric to the reliability target; and in response to the comparing thee is a yet further action which is at least one of a) signaling the multi-mode device an indication of the first set of multiple radio links that if utilized by the multi-mode device simultaneously would satisfy the single multi-link reliability target, and b) signaling the multi-mode device a notification of the single multi-link reliability metric associated with the first set.

According to a fourth embodiment from the perspective of the multi-mode device, there is an apparatus comprising at least one computer readable memory storing computer program instructions and at least one processor. The computer readable memory with the computer program instructions is configured, with the at least one processor, to cause a multi-mode device such as a user equipment to at least: receive from a radio network signaling that indicates at least a set of multiple radio links; and in response to receiving the signaling, use simultaneously the said set of multiple radio links to send data to the radio network. Further embodiments from this perspective include a method for performing the above steps as well as a computer readable memory storing a program of executable instructions that when executed cause a multi-mode device to perform such actions.

These and other aspects are detailed below with particularity.

### BRIEF DESCRIPTION OF THE DRAWINGS

FIG. 1A is a schematic diagram illustrating an example multi-link radio environment in which embodiments of these teachings may be practiced.

FIG. 1B is a high level schematic diagram of layers of the radio protocol architecture for the user plane in an eNB and in a gNB that are interfaced for 5G NR-LTE interworking, as may be deployed in the FIG. 1A radio environment.

FIG. 2 is a data plot of complementary cumulative distribution function (CCDF) versus achievable latency for multiple system load rates in a LTE system showing single-link connectivity is insufficient for certain demanding applications.

FIG. 3 is a process flow diagram summarizing certain of the above teachings and showing both a network-controlled approach and a network-assisted approach for ensuring multi-link communications satisfy a reliability metric according to embodiments of these teachings.

FIG. 4 is a high level schematic block diagram illustrating certain apparatus/devices that are suitable for practicing certain of these teachings.

### DETAILED DESCRIPTION

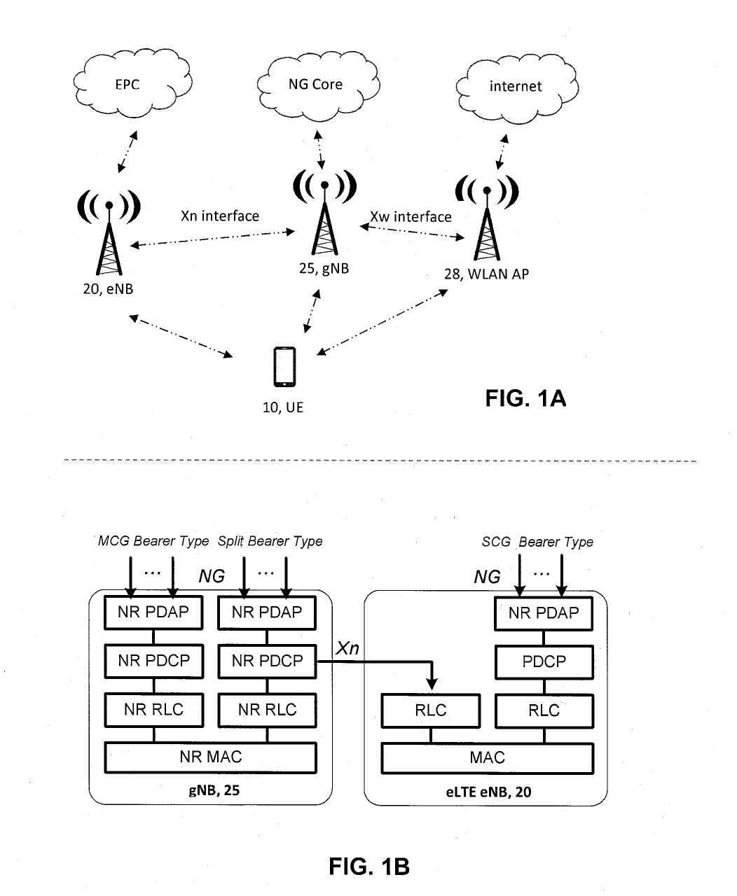

Consider again the example radio environment of FIG. 1A. As applications for cyber-physical systems (CPS) require the reliability to be guaranteed deterministically because of their mission critical nature, a mission-critical device such as the UE 10 of FIG. 1A will likely require multi-link access connectivity in order to make sure to meet the stringent reliability requirements. In this regard multi-link connectivity refers to the capability of the device to be connected with more than one radio link at the same time.

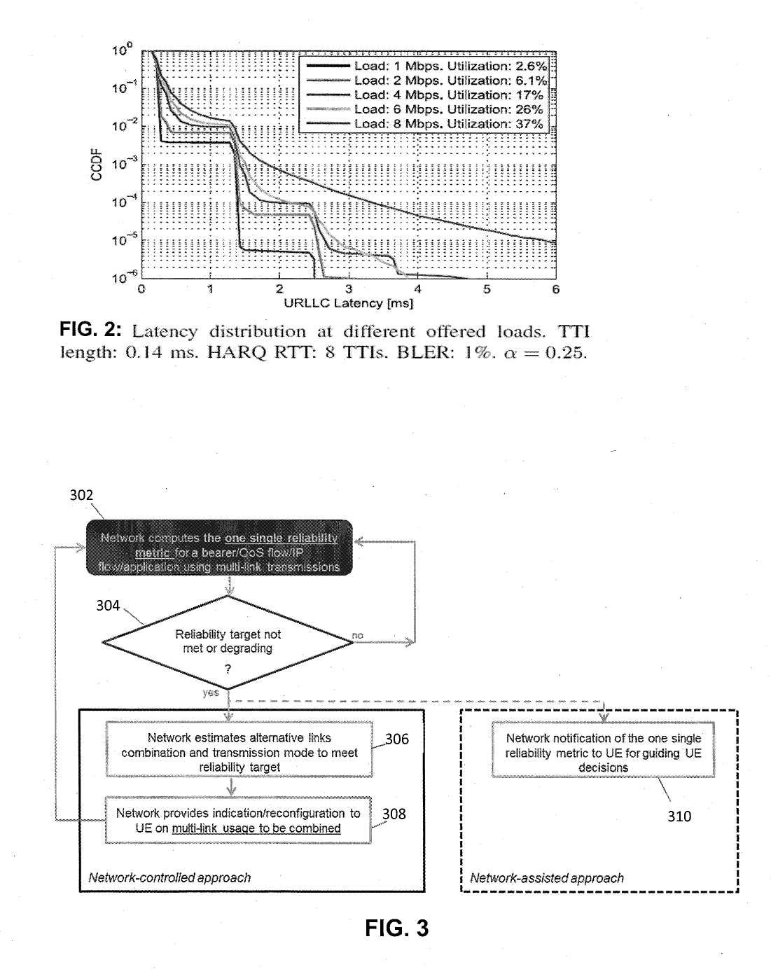

FIG. 2 is a plot of complementary cumulative distribution function (CCDF) versus achievable latency for multiple system load rates (in mega-bits per second MBPS) derived from the Applicant's own work and confirms that strict requirements (generally less than 10 ms latency) cannot be met by using only the LTE system, even with mechanisms for implementing a short transmission time interval (TTI) of 0.14 ms. FIG. 2 shows this is true even at relatively low load levels. Additionally, the multi-link connectivity will be required anyway because the handover of a single-link is generally based on break-before-make procedures, where the link to the source radio access node is broken before the link to the target access node is established. This is true in LTE and many RATs. So even if a single link could meet more stringent latency requirements this break-before-make characteristic would very likely violate the reliability requirement.

As outlined in the background section above, the multi-link decision is generally about whether to use a single link or multiple links at any given time among the available ones, and if multiple links which ones. Consider how complex that would be for the radio environment of FIG. 1A. In the downlink direction, the radio network can be assumed in control on how to serve the user to meet the reliability targets, for example relying on some interworking arrangement with other RATs. This is not entirely true in the uplink direction, where the network remains in full control of the resources to use only in the cases of scheduled systems. In the FIG. 1 example the LTE eNB and the 5G NR gNB will send to the UE a scheduling grant to give it the right to transmit, and this grant also identifies to the UE which uplink resources are assigned for that uplink transmission. In other radio systems such as WLAN, the UE would need to compete for access to the radio medium and simply use the uplink radio resource once it obtains one using established and standardized procedures such as the listen-before-talk (LBT) procedure in WLAN. These uplink transmissions are not scheduled by the radio network. Importantly, non-scheduled (e.g., grant-free) operations are envisioned for use also in 5G NR systems for supporting URLLC, meaning a mission critical device can transmit its data immediately as that data appears in the device's uplink buffer without waiting for scheduling grants. In 5G this non-scheduled/grant-free operation is expected to be based on some pre-allocations of radio resources.

This means that in any scenario where at least one of the multiple radio links available to the device uses non-scheduled operations, the UE will have to determine the uplink transmission mode/links. Consider the example of LTE-WLAN aggregation (LWA) where the uplink transmission mode is to be largely controlled by the UE in that it is the UE that determines, based on its own logic, how to serve the traffic via LTE and/or via WLAN. The network provides only a threshold depending on the UE's amount of buffered data to indicate when the UE can start using a split bearer, i.e. splitting/aggregating the data belonging to one bearer across LTE and WLAN interfaces (and in principle could also release the LWA configuration altogether in case of poor performance).

UE-controlled and best-effort mechanisms to control the use of the active radio links, such as those above, is acceptable as long as the objective of the network interworking is capacity boosting in a best effort fashion. But in truth giving the UE a role in deciding which radio link on which to place its data may result, and in the inventors' opinion likely will result, in a sub-optimal use of network resources for the simple fact that the UE may not necessarily know or be able to compute the quality of a given link, such as for example the link delay of packets sent over that link. On the contrary, if the objective of the multi-link connectivity is to ensure a given reliability level, some different or additional mechanisms are required based on the measurement of the actual level of fulfilment of reliability. Where there is the possibility of non-scheduled operations such as grant-free uplink resource allocations mentioned above, these mechanisms need to consider also the most efficient provisioning of network resources to meet those targets.

Embodiments of the teachings below address these limitations, and provide methods and mechanisms for reliability-based multi-link decisions that are most advantageously deployed for mission critical devices. More specifically, the detailed examples below provide a method for reliability-based dynamic selection of one or more radio links for mission critical/high reliability services. As will be seen, this method can be applied either as network-controlled or network-assisted, depending on the assumed level of radio signaling and UE autonomy.

The reader will notice the following aspects of this method:
the simultaneous use of multiple links in transmission for reliability purposes;
network assessment and notification of one single reliability metric, which is based on and refers to the simultaneous or combined use and performance of multi-links; and
signaling of the multi-link usage (for example, sending an instruction for using two or more links) and the combined transmission mode.

The simultaneous use of multiple links in transmission means that the sending of an element of data for which the reliability metric is defined (such as a PDU or a message for example) is using the links in the set for that element of data. As mentioned above there are many different ways to send such an element of data over the multiple links and in further examples below the particular way a given element of data is sent is dependent on the transmission mode. For example, the element of data can be bi-cast or multi-cast on the multiple links of a given set. In some transmission modes the element of data can be sent on different links at the same instant in time, or there may be a delay between one link and another of the set of multiple links, or there may not be a time correlation for sending the element of data on those links. Typically the reliability metric will depend on the transmission mode being used for the multiple link set, not least because there is a delay budget or time aspect to the reliability metric and some of the different transmission modes may have different time relationships between the element of data sent on the different links.

These main aspects are detailed further below. For a wide scale implementation across multiple different RATs certain aspects of these teachings are best standardized, for example in a published radio standard for 5G NR. For example, the radio resource control (RRC) signalling and/or the 5G NR PDAP aspects can be standardized since those are the means to transfer to the UE the indication/notification detailed herein. Legacy systems such as LTE and WLAN can also adopt these in standardized form or they may realize these teachings in an implementation specific manner, preferably once they are standardized for 5G NR or some other public documentation.

FIG. 3 is a process flow diagram illustrating some of the major aspects of these teachings. It begins at block 302 where the network computes a single reliability metric for a bearer/QoS flow (or an IP flow as the case may be) using multi-link transmissions. In one embodiment, the network computes in real-time the achieved single multi-link reliability metric that is related to a UE's bearer or IP flow or QoS flow; this is different from computing an individual reliability metric associated with each different one of the multiple radio links that the UE is utilizing because that would be one metric per link rather than one metric per specific multi-link flow. In one embodiment the network computes this reliability metric for the multi-link flow based on the timing and success of the actual data packets transmitted on that flow. An estimate of the single reliability level which is achieved or could be achieved when using different link combinations and the metric can be computed based on any other information the network can acquire. Examples of such other measurements include but are not limited to:
measurements performed for other UEs;
historical measurements data gathered for the given UE, such as the achieved reliability of the data transmitted by the UE in the previous period;
measurements made making use of lower layer triggers and metrics such as the radio quality of the different links (for example based on UE measurement reporting);
network performance (for example this may be based on network level performance metrics of the other links which belong to different cells/RAT and that are exchanged across networks interfaces or relayed through the UE); and
protocol layer performance (for example these may be based on in-band measurements).

Above it is described the network computes the multi-link reliability metric. While embodiments of these teachings encompass multiple links over multiple different networks using different RATs, the ‘network’ performing the steps according to these teachings refers what may be considered a master node. While this may be known by a different name in certain deployments of these teachings, in function the master node refers to the network entity that has a certain level of control over all the links involved in the radio communications towards the UE and this master node is connected via well defined network interfaces to the other cells/access points/radio access nodes involved in the multi-connectivity communications. For instance, such a master node also takes care of data combining (e.g. reordering) the data that is sent from the UE via the different multiple uplinks. Such a master node can compute the single reliability metric based on all the acquired information from the multiple UEs being served, which report measurements related to all the networks/links, and the master node can further acquire the information needed to compute the multi-link reliability metric via direct exchange with the other network nodes/cells/links. As one example, during the early deployments of 5G NR when that RAT is not yet capable of standing alone the LTE eNB may serve as the master node in a LTE-5G NR interworking that serves a given UE, while in later deployments when 5G NR is fully capable of operating independently of other RATs the tight interworking may have the gNB acting as the master node to the LTE and WLAN AP ‘slave’ nodes while the multi-mode device (UE) has distinct but inter-worked uplinks with the gNB, the eNB and the WLAN AP simultaneously.

In one embodiment the achieved one/single reliability metric is computed so as to account for application and protocol performance based on each packet of a UE's data traffic, or each packet within a flow, or any packet of a given application or the entire “critical message” of a given application. What is a “message” would depend on the protocol used, and could be constructed based on inspecting packet headers via so called in-band measurements. So the granularity would depend on traffic profiling capabilities at the network side e.g. in identifying certain traffic types and application protocols, IP addresses, and so forth. In another embodiment the achieved reliability is computed on probabilistic terms, for example the measurement data is based only on a subset of packets or flows and that measurement data is extrapolated to the whole data flow.

The network (specifically, the master node) tracks the UE's data in the flow on the multi-links against the reliability metric at block 304. If the reliability target is met (or in some deployments if it is also expected to continue to be met, so for example the measured reliability is not degrading when it is within some threshold limit of the reliability target) then the FIG. 3 flow returns to step 302 and the network re-computes the reliability metric or confirms it is still valid. Since the network is controlling this operation (or assisting the UE in its selection of which multi-links to use) there is no need to inform the UE that the reliability target continues to be met, though embodiments of these teachings do not preclude such notifications to the UE. If alternatively the reliability target is not met (or is expected to be violated, in the near future) then the flow from block 304 is on the ‘yes’ branch to either block 306 for the network-controlled implementation or to block 310 for the network-assisted implementation.

In certain embodiments for the network controlled approach of FIG. 3, the network makes all the decisions as to which of the available links with the UE will be used to meet the reliability target or metric. In this case, if the network at block 304 finds that the reliability target is not met (or is predicted to not be met in the near future) then the process of FIG. 3 moves to block 306 in which the network estimates alternative link combinations and transmission modes, and from these selects one that is predicted to meet the reliability target metric. At block 308 the network informs the UE of this multi-link selection such as via an indication or a formal RRC reconfiguration of the UE's active links, after which the UE's data flow is communicated over the air interface on the newly selected links.

There are a variety of options for the network to signal at block 308 the indication of the multi-link combination(s) the UE should use to support the required single-metric reliability target. Such an indication could be provided along with the notification to the UE of reliability degradation or a failure to fulfill the reliability metric which may require the UE to utilize more links in order to still meet the reliability metric. In some embodiments the network will inform the UE that reliability has increased by at least some minimal amount which may enable the UE to utilize fewer links while still meeting the reliability metric; in this case the indication can be provided with the information about the reliability increase. In some embodiments the indication of block 308 can be provided in a scheduling grant that allocates uplink and/or downlink radio resources to the UE.

In some embodiments this indication at block 308 could indicate the transmission mode the UE is to use. A transmission mode for a given set of multi-link defines how to use each of the links composing the set to serve the UE's data for a certain data flow/bearer. Some examples of this transmission mode signaled to the UE include, but are not limited to:
“Pause using non-scheduled operations” or “Resume using non-scheduled operations” for the next prescribed period T;
“Send data over link(s) 1 and 3” among the available links (1, 2, . . . N) for the next prescribed period T;
“Send data with data split ratio X:Y between links 1 and 3”;
“Pause using link x” for the next prescribed period T;
“Use packet duplication (bicasting or multicasting)” through the combined links or a sub-selection of them for the next prescribed period T;
Usage of a subset of resources in a link or a set of links, such as certain frequencies.

In some embodiments the network at block 306 may find that there are multiple selections of multi-links sets that are estimated to meet the single reliability metric. In this case the network may inform the UE of only one of them as above, or it may inform the UE of two or more such selections and allow the UE to make the final choice among that very limited set of multi-link options the network presents to the UE. This embodiment may be considered a hybrid between the network-controlled approach of FIG. 3 detailed above and the network-assisted approach of FIG. 3 detailed below, since the UE chooses which multi-link it will adopt but that final UE decision is constrained by a very limited number (typically 2 or 3) of choices that the network offers it.

In certain embodiments for the network assisted approach of FIG. 3, the reliability level reached that the network checks at block 304 is provided to the UE at block 310 for example in the form of a binary fulfilled/not fulfilled. In various implementations this fulfilled/not fulfilled reliability information can be provided as the actual latency that the network provides with the required reliability target, or the actual reliability provided within the latency target, or as absolute or relative values; or with a mapping scale of quantized absolute values (where 1=reliability target not fulfilled through 5=fulfilled, for example).

In another embodiment, the one single reliability value is provided on a per bearer/flow (IP flow or QoS flow) granularity, and/or per traffic type. These are again different from individual reliability metrics per radio link since in this case there is one metric per multi-link combination. In another embodiment the network may provide to the UE/multilink device the indication that reliability is degrading for a certain bearer or flow and that it is degrading with a certain degradation delta (rate of change) as compared to the target.

There are quite a variety of options for the network to signal the reliability metric to the UE at block 310. For example the notification of the single multi-link metric expressing the reliability level reached or predicted in the future by the combined usage of multi-link(s) for a certain bearer/QoS flow can be provided in an existing signaling messages (for example, a new information element in an existing RRC message or an entirely new signaling message), or in-band using information elements in the user-plane packet headers (for example, a new dedicated field in the 5G NR PDCP header), or piggy-backed to the downlink data payload sent to the UE (for example at the NR PDAP layer, at the TCP/IP layer, or in an application protocol). The network may provide this notification conditional on the result of the comparison at block 3043 as FIG. 3 illustrates, that is, only when the network detects or predicts reliability degradation or failure to fulfill the metric. In some embodiments the network may also provide to the UE the level of degradation (as compared to the target metric) along with an indication of which link or links are experiencing degradation. Triggering of the block 310 notification due to the comparison at block 304 can be based on a threshold, for example reliability within X % of the metric while trending lower. In some embodiments there can also be a notification to the UE conditional on the reliability measure having improved. Whether degradation or improvement of the multi-link reliability is notified, in any of these embodiments the notification may be provided as an increment of reliability degradation (for example, Y % reliability degradation). The signaling of the reliability metric or improvement or degradation may also happen in form of a recommendation which links to use, or which links no longer need using, or should be used additionally.

Certain of the embodiments of these teachings provide the technical effect of ensuring that the required level of reliability is provided and enabling an effective reaction to situations where violation of the requirements are measured or anticipated. More broadly stated, one technical effect is that these teachings support/enable mission-critical/high reliability applications.

Consider a few practical examples how these teachings may advantageously be deployed. Assume a mission critical device has multiple radio links which may have different underlying RATs such as NR-LTE, NR-WLAN and LTE-WLAN. If the reliability level is signaled to the UE per block 310 of FIG. 3, the selection of links to use and how to use them (for example transmission mode and data split ratio, to name just two) to meet the requirement can be left up to the UE. At the same time, the network may signal to the UE the selection of links that could be used, and how to use them, in order to achieve a defined reliability target. This would relieve the UE of the burden of determining the multi-link usage itself. In the other FIG. 3 embodiment the network could indicate at block 308 those link selections and how to use them dynamically to achieve he reliability target, based on the network's own estimates which it can perform quite quickly.

In one example, if 5G NR is one of the available radio links then sustaining the needed reliability would benefit from a fast switch between using non-scheduled operations versus using scheduled operations over the 5G NR link in addition to one or more secondary link. Ideally the non-scheduled operations should be minimized due to inherent radio spectrum efficiency costs these entail, for example due to the procedures they use to minimize collisions in the pre-reserved resources, as well as due to the QoS degradation costs in case collisions occur. In another example when a wireless hybrid network that includes legacy wireless systems is used to provide high reliability, in-band indications of the achieved reliability can be provided to the UE (for example, in the TCP/IP header) with minimal impact to the UE, and these in-band indications could assist the UE in future multi-link decisions. As final examples, autonomous driving and control of drones are mission critical applications for which failure to meet reliability targets can have serious consequences. Applications for autonomous driving or drone control can benefit from adopting these teachings in that guaranteeing the necessary reliability is a direct improvement to the safe operation of the system.

As a review of some of the above more detailed examples, in one embodiment there is a method comprising determining a reliability target for radio communications. The network also computes a first single multi-link reliability metric with a multi-mode device across a first set of multiple radio links that can be used simultaneously for the multi-mode device. As detailed more particularly above, the single multi-link reliability metric enumerates an overall probability to successfully communicate a certain volume of digital data within a certain time constraint. Block 302 of FIG. 3 shows this computing step, and as detailed above the single multi-link reliability metric can be for example, X bits or bytes within some specified delay budget. Next in the method the network compares the first single multi-link reliability metric to the reliability target, and this was detailed with respect to block 304 of FIG. 3. Finally in the method the network, in response to that comparing, signals the multi-mode device in at least one of two ways. As block 308 of FIG. 3 describes one way is to signal the multi-mode device an indication of the first set of multiple radio links that are selected to satisfy the single multi-link reliability target (that is, if the device utilizes the first set of multiple radio links simultaneously its radio communications would satisfy the reliability target), and block 310 of FIG. 3 describes another way in that the network signals the multi-mode device a notification of the single multi-link reliability metric associated with the first set.

In one particular deployment of these teachings the first set of multiple radio links includes a first link utilizing a first radio access technology such as 5G NR or LTE and a second link utilizing a different second radio access technology such as the other of 5G NR or LTE. Some RATs have non-scheduled operations and so if we assume the second RAT is for example Wi-Fi (formally, IEEE 802.11) and the first RAT is LTE, (at least some of) the radio communications on the first link are scheduled by resource grants to the multi-mode device and (at least some of) the radio communications on the second link are not scheduled by resource grants to the multi-mode device. This may also be at least partly true if 5G NR is the second RAT if it comes to pass that 5G NR is deployed to allow certain resources to be set aside in advance for non-scheduled operations.

These teachings may be deployed to advantage specifically when there is a mission critical application, in which case the reliability target may be determined based on that application which is deemed to be mission critical. The radio communications at issue may be categorized as, or consist of, a QoS flow or an IP flow for the multi-mode device.

Now consider an example where the network also computes a second single multi-link reliability metric with a multi-mode device across a second set of multiple radio links that can be used simultaneously for the multi-mode device. In this case the first set and the second set may or may not be overlapping in that there may or may not be at least one radio link in common between these two sets. In this case the network would also compare the second single multi-link reliability metric to the reliability target. Only if the comparing shows that the reliability target would be satisfied by the first single multi-link reliability metric would the network send to the multi-mode device the indication of the first set and/or the notification of the single multi-link reliability metric associated with the first set. Further, if this further comparing shows that the reliability target would not be satisfied by the second single multi-link reliability metric then the network would not send to the multi-mode device an indication of the second set and/or a notification of the single multi-link reliability metric associated with the second set, but in some embodiments if that further comparing shows the reliability target would be satisfied by the second reliability metric then the network may send to the device the indication of the second set and/or the notification of the reliability metric associated with the second set, in addition to that of the first set.

If the UE was previously using a first multi-link set, and the network wants to indicate a second multi-link set to the UE, the network may do so in incremental fashion, by signaling which links should no longer be used and/or which links should be additionally used. So for example if we assume the UE's initial multi-link set that includes links A, B, C and D begins to deteriorate, the network can indicate a first multi-link set {A, B, D, E} to the UE by signaling it to drop link C and add link E and at some later time can indicate a second multi-link set {D, E, F} to the UE by signaling it to drop links A and B and add link F. In more general terms this can be regarded as the network signaling the indication of the first set of multiple radio links by identifying only incremental differences over a previous set of multiple radio links that the first set is to replace. The signaling for the first set is coded with reference to the previous set.

As further detailed above, in some embodiments the indication or notification comprises a dedicated field in a header of a user-plane data packet, and/or a control plane message such as a radio resource control (RRC) message and/or an information element within a RRC message. In addition to this indication/notification, the network can in some embodiments also send the multi-mode device further information about the comparing done at block 304 of FIG. 3, for example a further indication that the reliability of the radio communications is deteriorating or improving.

The above examples detailed that the computing and the comparing and the signaling are done in response to the network determining that the current radio communications with the multi-mode device do not satisfy the reliability target, or is anticipated to not satisfy the reliability target. And in some further embodiments, when the network signals the device with the indication or the notification the network may also send to the device/UE information about transmission mode to use for the radio communications. Many such transmission mode examples are set forth in a bulleted list above.

Various of these aspects may be practiced individually or in any of various combinations. While the above description of FIG. 3 is from the perspective of the network, the skilled artisan will recognize that these support corresponding behavior on the part of the UE 10. Further, since these teachings can be deployed where there is a hybrid network or multiple networks cooperating with one another to serve a UE with individual ones of the multiple links, typically the serving node (for example, the gNB in FIG. 1A) would be master node which is the entity to make the determination of the single multi-link reliability metrics for various sets of links and to do the comparing, though it will typically collect information as to throughput, error rate, and the like from the other ‘slave’ or ‘interworked’ network nodes (eNB and WLAN AP in the FIG. 1A example) in order to make those computations.

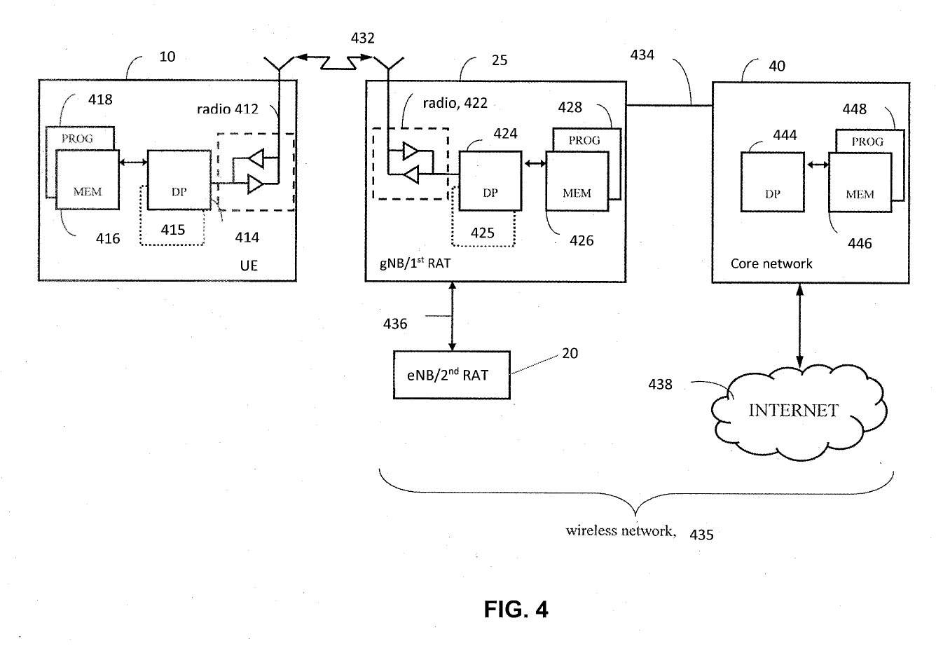

As an example of such corresponding behavior on the part of the UE 10, there may be an apparatus (such as the multi-mode device itself or components thereof) that comprises at least one computer readable memory storing computer program instructions, and at least one processor as detailed below for the UE 10 of FIG. 4. Such a computer readable memory with the computer program instructions may be configured, with the at least one processor, to cause the multi-mode device to receive from a radio network signaling that indicates at least a set of multiple radio links. In different embodiments this signaling to the UE/multi-mode device may or may not further include an associated single multi-link reliability metric. Then in response to receiving the signaling, the multi-mode device is caused to use simultaneously the signaled set of multiple radio links to send data to the radio network.

As detailed more fully above, in an advantageous deployment the received signaling indicates a first set of multiple radio links and further indicates a second set of multiple radio links and also information that the first set and the second set each meet a reliability target (these reliability targets may differ for the different sets, so there is a first reliability target associated with the first set and a second reliability target associated with the second set). In this embodiment, further in response to receiving the signaling the multi-mode device selects from among the first and second sets based on at least one performance criteria such as for example optimizing power consumption at the multi-mode device. The set of multiple radio links that the device uses simultaneously to send data to the radio network is therefore the selected first set or second set.

In a particular embodiment in which the set of multiple radio links is a first set and the received signaling further indicates a first single multi-link reliability metric associated with the first set, the computer readable memory with the computer program instructions is configured with the at least one processor to cause the multi-mode device to further receive from the radio network a) an indication that the first single multi-link reliability metric associated to the first set does not satisfy a reliability target or is anticipated to not satisfy the reliability target; and b) a second set of multiple radio links and an associated second single multi-link reliability metric that satisfies the reliability target. In this particular embodiment, in response to the further signaling the multi-mode device receives the device changes from the first set to the second set for continued communications with the radio network. To be clear, the first set and the second set are not identical.

In another particular embodiment the received signaling further indicates directly a transmission mode the multi-mode device is to adopt when using simultaneously the said set of multiple radio links to send data to the radio network. In some instances the network can signal this with the set of multiple radio links, or in other instances the network can signal this separately in which case the multi-mode device can continue using its current set of links but with the changed transmission mode so as to continue meeting the reliability target. If the network is signaling to the device the reliability metric for a given set of links, then in the latter case the network may also signal a new reliability metric associated with the current set and the newly signaled transmission mode since changing the transmission mode would yield a different reliability metric.

The above actions described from the perspective of the multi-mode device as apparatus can also be embodied in a practical deployment as a method, and/or as a computer readable memory storing computer program instructions that, when executed by one or more processors, cause a multi-mode device to perform those described actions.

FIG. 4 is a high level diagram illustrating some relevant components of various communication entities that may implement various portions of these teachings, including a master radio network access node shown in FIG. 4 as a gNB 25 that is operating on a first RAT (5G NR) and which is further in communication with a core network 40 which may also be co-located with a serving gateway (S-GW). FIG. 4 further shows a user equipment (UE) 10, and a second radio network access node shown in FIG. 4 as an eNB 20 that is operating on a second RAT (LTE) different from the first RAT. In the wireless radio environment of FIG. 4 the gNB 25 operating with the first RAT is adapted for communication over a wireless link 432 with an apparatus, such as a multi-mode mobile communication device which may be referred to as a UE 10. The gNB 25 operating on the first RAT may provide via the core network/serving gateway 40 connectivity with other and/or broader networks such as a publicly switched telephone network and/or a data communications network (e.g., the internet 438).

The UE 10 includes a controller, such as a computer or a data processor (DP) 414 (or multiple ones of them), a computer-readable memory medium embodied as a memory (MEM) 416 (or more generally a non-transitory program storage device) that stores a program of computer instructions (PROG) 418, and a suitable wireless interface, such as multiple radio frequency (RF) transceivers or more generically radios 412, for bidirectional wireless communications with the gNB 25 and the eNB 20 via one or more antennas. In general terms the UE 10 can be considered a machine that reads the MEM/non-transitory program storage device and that executes the computer program code or executable program of instructions stored thereon. While each entity of FIG. 4 is shown as having one MEM, in practice each may have multiple discrete memory devices and the relevant algorithm(s) and executable instructions/program code may be stored on one or across several such memories.

In general, the various embodiments of the UE 10 can include, but are not limited to, mobile user equipments or devices having wireless communication capabilities, including smartphones, wireless terminals, portable computers, image capture devices, gaming devices, music storage and playback appliances, Internet appliances, machine-type communication devices, vehicle-mounted internet devices, smart-home/Internet-of-Things type devices, as well as portable units or terminals that incorporate wireless communications capabilities.

The gNB 25 also includes a controller, such as a computer or a data processor (DP) 424 (or multiple ones of them), a computer-readable memory medium embodied as a memory (MEM) 426 that stores a program of computer instructions (PROG) 428, and a suitable wireless interface, such as a RF transceiver or radio 422, for communication with the UE 10 via one or more antennas. The gNB 25 is coupled via a data/control path 434 to the core network/S-GW 40. The path 434 may be implemented as a RAN-CN interface. The gNB 25 may also be coupled to other radio network access nodes operating with the same first RAT via another interface.

The gNB 25 may further be coupled to a second network access node such as the eNB 20 operating with a different second RAT via a data/control path 436 which may be implemented as a wired or wireless Xn interface. Relevant components of the eNB 20 are substantially similar to those detailed for the gNB 25 and so are not repeated, except to note that the gNB 25 operates at much higher frequencies than the eNB 20, typically will have a much higher number of antennas, and is anticipated to be dispersed in that the antennas are disposed at remote radio heads (RRHs) that are remote from the baseband processing functionality (one or more baseband units BBUs). Both the RRHs and the BBUs will each have their own data processor DP and computer-readable memory MEM storing programs of computer instructions PROGs, but the majority of memory and processing capability is to be in the BBUs of the gNB 25.

Referring again to the first RAT/5G NR system, the core network 40 includes a controller, such as a computer or a data processor (DP) 444 (or multiple ones of them), a computer-readable memory medium embodied as a memory (MEM) 446 that stores a program of computer instructions (PROG) 448.

At least one of the PROGs 418, 428 (and also in the eNB 20) is assumed to include program instructions that, when executed by the associated one or more DPs, enable the device to operate in accordance with exemplary embodiments of this invention. That is, various exemplary embodiments of this invention may be implemented at least in part by computer software executable by the DP 414 of the UE 10; and/or by the DP 424 of the gNB 25 or of the eNB 20; and/or by hardware, or by a combination of software and hardware (and firmware).

For the purposes of describing various exemplary embodiments in accordance with this invention the UE 10 and the gNB 25 (as well as the eNB 20) may also include dedicated processors 415 and 425 respectively. There may also be dedicated processors in either or both of the RRHs and the BBUs of the gNB 25.

The computer readable MEMs 416, 426, 446 and also of the eNB 20 may be of any memory device type suitable to the local technical environment and may be implemented using any suitable data storage technology, such as semiconductor based memory devices, flash memory, magnetic memory devices and systems, optical memory devices and systems, fixed memory and removable memory. The DPs 414, 424, 444 and also of the eNB 20 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 412 and 422 and of the eNB 20) may be of any type suitable to the local technical environment and may be implemented using any suitable communication technology such as individual transmitters, receivers, transceivers or a combination of such components.

A computer readable medium may be a computer readable signal medium or a non-transitory computer readable storage medium/memory. A non-transitory computer readable storage medium/memory does not include propagating signals and may be, for example, but not limited to, an electronic, magnetic, optical, electromagnetic, infrared, or semiconductor system, apparatus, or device, or any suitable combination of the foregoing. Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

A communications system and/or a network node/base station may comprise a network node or other network elements implemented as a server, host or node operationally coupled to a remote radio head. At least some core functions may be carried out as software run in a server (which could be in the cloud) and implemented with network node functionalities in a similar fashion as much as possible (taking latency restrictions into consideration). This is called network virtualization. “Distribution of work” may be based on a division of operations to those which can be run in the cloud, and those which have to be run in the proximity for the sake of latency requirements. In macro cell/small cell networks, the “distribution of work” may also differ between a macro cell node and small cell nodes. Network virtualization may comprise the process of combining hardware and software network resources and network functionality into a single, software-based administrative entity, a virtual network. Network virtualization may involve platform virtualization, often combined with resource virtualization. Network virtualization may be categorized as either external, combining many networks, or parts of networks, into a virtual unit, or internal, providing network-like functionality to the software containers on a single system.

The following abbreviations that may be found in the specification and/or the drawing figures are defined as follows:

AC access controller

AP access point

ARP allocation and retention priority

CN core network

CPS cyber-physical systems

D2D device to device

DL downlink

eNB evolved nodeB

gNB next generation radio access node (5G NB)

HARQ hybrid ARQ

IE information element

IEEE institute of electrical and electronics engineers (standardization body)

IETF internet engineering task force (standardization body)

HRLLC high reliability low latency communications

LTE long term evolution (of E-UTRA)

LWA LTE WLAN aggregation

MP-TCP multi-path TCP

NR new radio (also known as 5^{th} Generation or 5G)

PDAP PDCP application protocol (?)

PDCP packet data convergence protocol (protocol layer)

PDU protocol data unit

QoS quality of service

RAN radio access network

RAT radio access technology

RRC radio resource control

RTT round trip time

SDU service data unit

TTI transmission time interval

UL uplink

UMTS universal mobile telecommunications service

URLLC ultra reliability low latency communications

WLAN wireless LAN

Xw interface between 3GPP eNB and WLAN Termination for LWA

What is claimed is:

1. A method comprising:
determining a reliability target for radio communications;
computing a first single multi-link reliability metric with a multi-mode device across a first set of multiple radio links that can be used simultaneously for the multi-mode device;
comparing the first single multi-link reliability metric to the reliability target; and
in response to the comparing, signaling to the multi-mode device at least one of:
an indication of the first set of multiple radio links that if utilized by the multi-mode device simultaneously would satisfy the reliability target; and
a notification of the single multi-link reliability metric associated with the first set.

2. The method according to claim 1, wherein the first set of multiple radio links includes a first link utilizing a first radio access technology and a second link utilizing a different second radio access technology.

3. The method according to claim 2, wherein the radio communications on the first link are scheduled by resource grants to the multi-mode device and the radio communications on the second link are not scheduled by resource grants to the multi-mode device.

4. The method according to claim 1, wherein the reliability target is determined based on an application deemed to be mission critical.

5. The method according to claim 1, further comprising:
computing a second single multi-link reliability metric with a multi-mode device across a second set of multiple radio links that can be used simultaneously for the multi-mode device; and
comparing the second single multi-link reliability metric to the reliability target.

6. The method according to claim 5, further comprising:
sending to the multi-mode device the indication of the first set and/or the notification of the single multi-link reliability metric associated with the first set only if the comparing shows that the reliability target would be satisfied by the first single multi-link reliability metric, and
not sending to the multi-mode device an indication of the second set and/or a notification of the single multi-link reliability metric associated with the second set if the comparing shows that the reliability target would not be satisfied by the second single multi-link reliability metric.

7. The method according to claim 1, wherein the indication of the first set identifies incremental differences over a previous set of multiple radio links that the first set is to replace.

8. The method according to claim 1, the method further comprising sending to the multi-mode device further information about the comparing including at least a further indication that the reliability of the said first set is deteriorating or improving.

9. The method according to claim 1, wherein the computing and the comparing and the signaling are in response to determining that current radio communications with the multi-mode device do not satisfy the reliability target, or are anticipated to not satisfy the reliability target.

10. The method according to claim 9, the method further comprising, in response to the determining, sending to the multi-mode device information about transmission mode to use for the radio communications.

11. An apparatus comprising:
at least one computer readable memory storing computer program instructions, and
at least one processor;
wherein the computer readable memory with the computer program instructions is configured, with the at least one processor, to cause the apparatus to at least:
determine a reliability target for radio communications;
compute a first single multi-link reliability metric with a multi-mode device across a first set of multiple radio links that can be used simultaneously for the multi-mode device;
compare the first single multi-link reliability metric to the reliability target; and
in response to the comparing, signal to the multi-mode device at least one of:
an indication of the first set of multiple radio links that if utilized by the multi-mode device simultaneously would satisfy the reliability target; and
a notification of the single multi-link reliability metric associated with the first set.

12. The apparatus according to claim 11, wherein the first set of multiple radio links includes a first link and a second link characterized by at least one of:
the first link utilizes a first radio access technology and the second link utilizes a different second radio access technology; and
the radio communications on the first link are scheduled by resource grants to the multi-mode device and the radio communications on the second link are not scheduled by resource grants to the multi-mode device.

13. The apparatus according to claim 11, wherein the computer readable memory with the computer program instructions is configured with the at least one processor to cause the apparatus to further:
compute a second single multi-link reliability metric with a multi-mode device across a second set of multiple radio links that can be used simultaneously for the multi-mode device; and
compare the second single multi-link reliability metric to the reliability target.

14. The apparatus according to claim 13, wherein the computer readable memory with the computer program instructions is configured with the at least one processor to cause the apparatus to further:
send to the multi-mode device the indication of the first set and/or the notification of the single multi-link reliability metric associated with the first set only if the comparing shows that the reliability target would be satisfied by the first single multi-link reliability metric, and
not send to the multi-mode device an indication of the second set and/or a notification of the single multi-link reliability metric associated with the second set if the comparing shows that the reliability target would not be satisfied by the second single multi-link reliability metric.

15. The apparatus according to claim 11, wherein the indication of the first set identifies incremental differences over a previous set of multiple radio links that the first set is to replace.

16. The apparatus according to claim 11, wherein the computer readable memory with the computer program instructions is configured with the at least one processor to cause the apparatus to further send to the multi-mode device further information about the comparing including at least a further indication that the reliability of the said first set is deteriorating or improving.

17. The apparatus according to claim 11, wherein the apparatus computes as said and compares as said and signals as said in response to determining that current radio communications with the multi-mode device do not satisfy the reliability target, or are anticipated to not satisfy the reliability target.

18. A computer readable memory storing computer program instructions that, when executed by one or more processors, cause a master radio access node operating with at least a first RAT, to perform actions comprising:
determining a reliability target for radio communications;
computing a first single multi-link reliability metric with a multi-mode device across a first set of multiple radio links that can be used simultaneously for the multi-mode device;
comparing the first single multi-link reliability metric to the reliability target; and
in response to the comparing, signaling to the multi-mode device at least one of:
an indication of the first set of multiple radio links that if utilized by the multi-mode device simultaneously would satisfy the reliability target; and
a notification of the single multi-link reliability metric associated with the first set.

19. The computer readable memory according to claim 18, wherein the first set of multiple radio links includes a first link and a second link characterized by at least one of:
the first link utilizes a first radio access technology and the second link utilizes a different second radio access technology; and
the radio communications on the first link are scheduled by resource grants to the multi-mode device and the radio communications on the second link are not scheduled by resource grants to the multi-mode device.

20. The computer readable memory according to claim 18, the actions further comprising:
computing a second single multi-link reliability metric with a multi-mode device across a second set of multiple radio links that can be used simultaneously for the multi-mode device; and
comparing the second single multi-link reliability metric to the reliability target.

21. An apparatus comprising:
at least one computer readable memory storing computer program instructions, and
at least one processor;
wherein the computer readable memory with the computer program instructions is configured, with the at least one processor, to cause a multi-mode device to at least:
receive from a radio network signaling that indicates at least a set of multiple radio links, and
in response to receiving the signaling, use simultaneously the said set of multiple radio links to send data to the radio network.

22. The apparatus according to claim 21, wherein the received signaling indicates a first set of multiple radio links and a second set of multiple radio links and information that the first set and the second set each meet a reliability target;
further where in response to receiving the signaling, the multi-mode device selects from among the first and second sets based on at least one performance criteria;
and wherein the said set of multiple radio links that are used simultaneously to send data to the radio network is the selected first set or second set.

23. The apparatus according to 21, wherein the set of multiple radio links is a first set and the received signaling further indicates a first single multi-link reliability metric associated with the first set;
and wherein the computer readable memory with the computer program instructions is configured with the at least one processor to cause a multi-mode device to further:
receive from the radio network:
an indication that the first single multi-link reliability metric associated to the first set does not satisfy a reliability target or is anticipated to not satisfy the reliability target; and
a second set of multiple radio links and an associated second single multi-link reliability metric that satisfies the reliability target,
and in response to the further receiving, change from the first set to the second set for continued communications with the radio network, wherein the first set and the second set are not identical.

24. The apparatus according to claim 21, wherein the received signaling further indicates directly a transmission mode to adopt when using simultaneously the said set of multiple radio links to send data to the radio network.
